(19) United States
(12) Patent Application Publication
(10) Pub. No.: US 2016/0373402 A1
(43) Pub. Date: Dec. 22, 2016

(54) Information Management and Notification System

(71) Applicant: Bank of America Corporation, Charlotte, NC (US)

(72) Inventor: Farel Jamin Becker, Charlotte, NC (US)

(21) Appl. No.: 14/745,660

(22) Filed: Jun. 22, 2015

(51) Int. Cl. H04L 12/58; H04L 29/08

(52) U.S. Cl. CPC H04L 51/34; H04L 67/025

(57) ABSTRACT

Aspects of the disclosure relate to methods, systems, and apparatuses for an information management and notification system. The system provides a centralized location and interface for managing information relevant to and used by various groups of users. In some aspects, the system can determine access permissions of a user of a computing device and determine information available to the user based on the access permissions of the user. The computing device can determine a current status of information submissions, preliminary reports (e.g., reports requiring approval and/or assistance), and completed reports based on the access permissions of the user. The system can determine that at least one notification event of a plurality of notification events has occurred. The plurality of notification events can include that a new information submission has been received, a report generation request has been submitted, an assistance request has been submitted, and a completed report has been submitted. In response to determining that the at least one notification event has occurred, the system can generate and display a notification indicating how many of the at least one notification event has occurred and which of the at least one notification event has occurred based on the access permissions of the user.

### BACKGROUND

In an organization, different people may have different responsibilities. The ability to perform these responsibilities may depend on requesting and receiving information from other people. The requests for information may be received via various sources such as e-mail, telephone, etc. It may be inefficient and tedious to constantly monitor whether requested information has been submitted or received or whether requests have been completed and the status of various pieces of information.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, systems, and apparatuses for an information management and notification system. The system provides a centralized location and interface for managing information relevant to and used by various groups of users. In some aspects, the system can determine access permissions of a user of a computing device and determine information available to the user based on the access permissions of the user. The computing device can determine a current status of information submissions, preliminary reports (e.g., reports requiring approval and/or assistance), and completed reports based on the access permissions of the user. The system can determine that at least one notification event of a plurality of notification events has occurred. The plurality of notification events can include that a new information submission has been received, a report generation request has been submitted, an assistance request has been submitted, and a completed report has been submitted. In response to determining that the at least one notification event has occurred, the system can generate and display a notification indicating how many of the at least one notification event has occurred and which of the at least one notification event has occurred based on the access permissions of the user.

In some aspects, the system can include a search function which identifies information based on user defined rules and include a bug report function. The system can also include a submission quality score calculation indicating the quality of the description in the information submission.

Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example user interface of the document notification tool according to one or more aspects described herein.

FIG. 4 illustrates an example method of information submission and notification according to one or more aspects described herein.

FIG. 5 illustrates an example method of report monitoring and notification according to aspects described herein.

FIG. 6 illustrates an example method of requesting and viewing reports according to aspects described herein.

FIG. 7 illustrates an illustrative user interface of a search panel according to aspects described herein.

FIG. 8 illustrates an example method of identifying relevant data according to aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

Various aspects described herein may relate to an information management and notification system. The system may be a business intelligence system. The information management system may determine which users of the system have access to particular types of information and enable users to submit information to the system. The information system may limit access to information based on a user's access privileges and/or roles. The system may notify users of information submitted to the system.

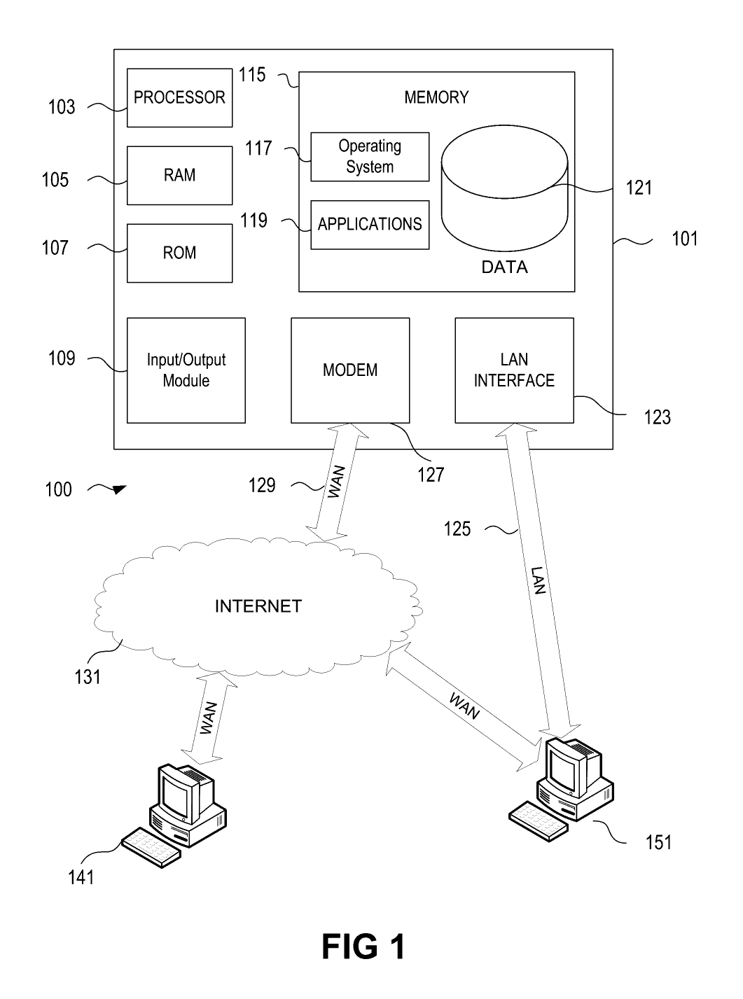

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

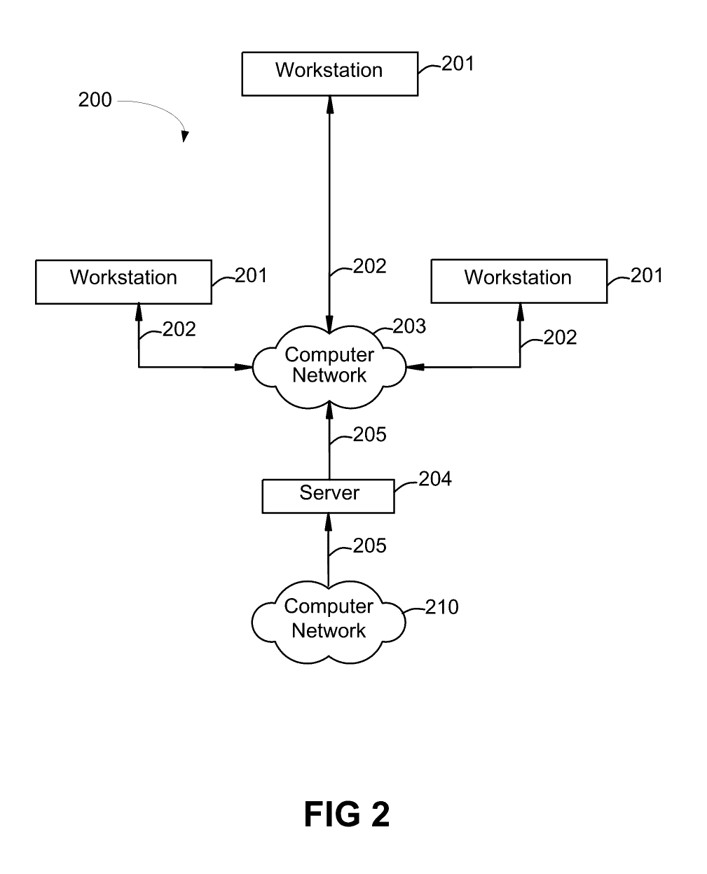

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

The information management and notification system may be a business intelligence system and may include a component which is executed on individual computing devices 101, 141, 151, or workstations 201. The component may be a tool providing a user interface for the system in the form of an application executing on the computing devices or workstations which may be implemented using the Java language. The tool may run in the foreground where the user can view and interact with the user interface of the tool. The tool may have a background mode in which the user interface is not visible and the tool continues checking for updates and notifications. The background mode may be a mode in which the tool continues running in the system tray of an operating system.

Upon launching the tool, the tool can determine what the access permissions of the user are. For example, there may be more than one team or group that a user can be associated with, and information can be accessible only to members of a team. In other words, if the user is a member of a first team but not of a second team, the user can view information directed to or associated with the first team and not information directed to or associated with a second team. In addition to team associations, a user may have a particular role such as a reviewer, investigator, administrator, and/or report generator. Based on the user's access permissions, the tool can scan all storage locations associated with various types of information (e.g., information submissions, assistance required documents, completed reports) which are accessible to the particular user of the computing device to determine the number and last modification of any data or documents in the storage locations. The tool can store this information and generate and display notifications in response to notification events such as any changes in this information (e.g., adding a new file to the storage location, modifying an existing file). The notifications shown to a particular user may depend on the user's role. A user who is a member of more than one team can switch between viewing information associated with the different teams.

Each information type may have a designated storage location where the tool will check for information to show the user. For example, information submissions may be stored in a specified folder and/or a specified file. Assistance required documents and completed reports may be stored in a similar manner. An administrator console can be used to configure the storage location and/or file name for each information type. The storage locations may be on a server 204 and/or database 121 that is accessible to other devices in a network. The information submissions may be related to cyber security and/or business risk situations and may have a case identifier associated with the submission. Information (e.g., cases, submissions, reports) may be moved between different statuses by changing the storage locations and/or names of the files and the system may periodically scan and refresh the data in the system.

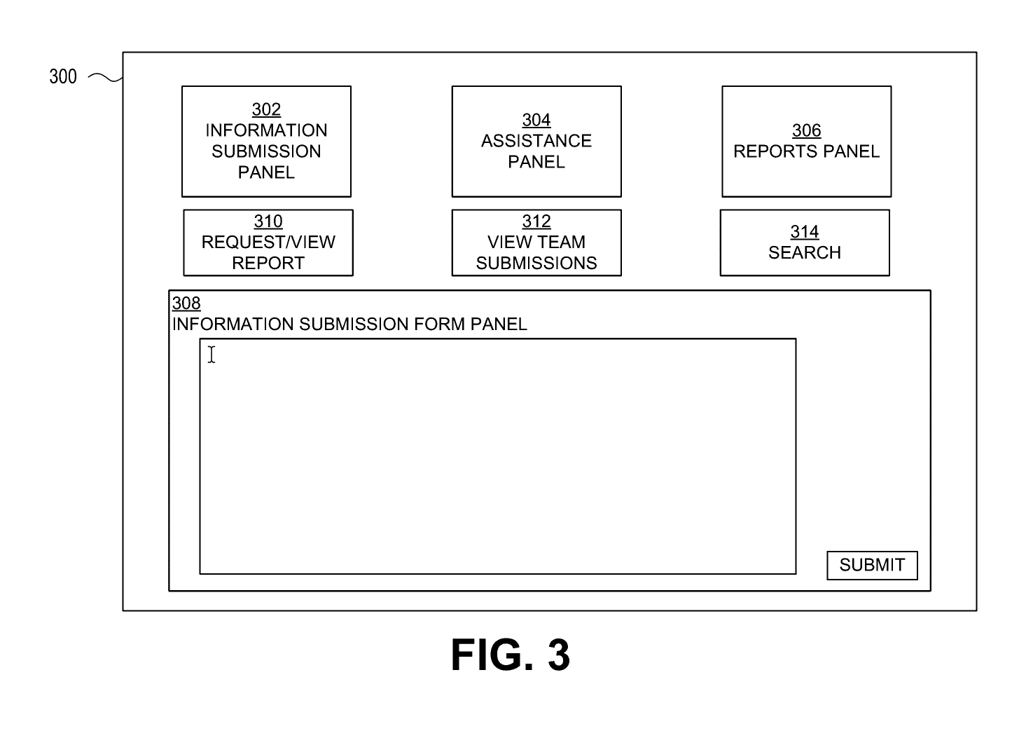

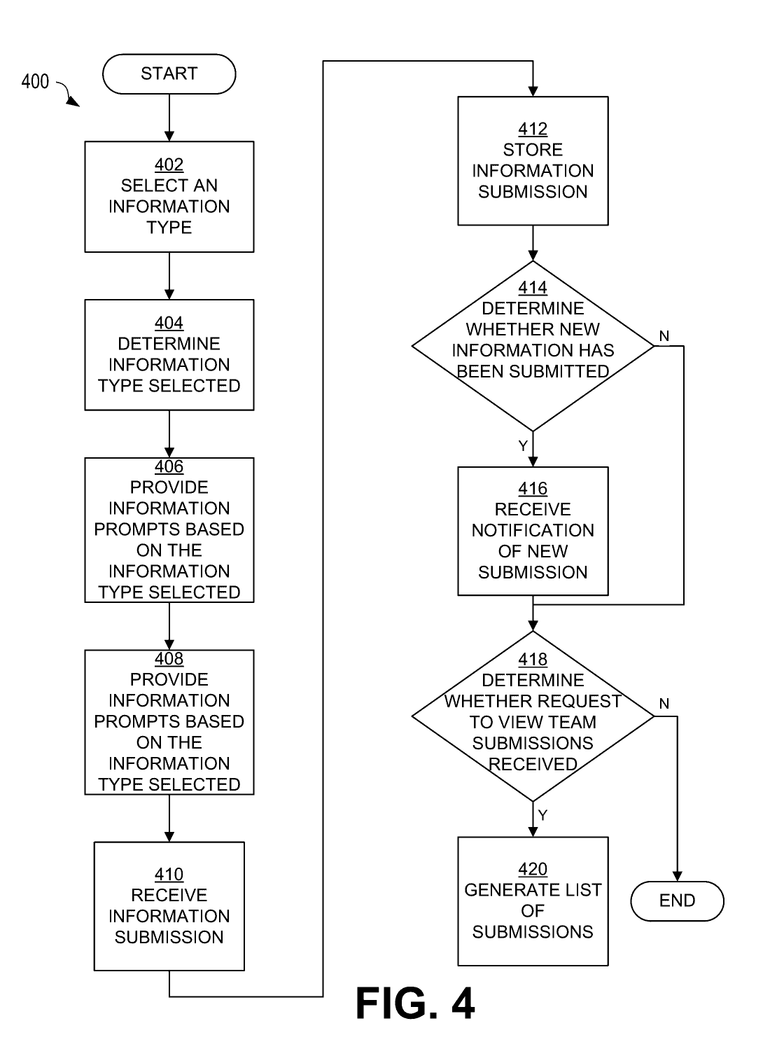

FIG. 3 shows an illustrative user interface 300 of the component or tool of the information management and notification system according to one or more aspects described herein. The user interface 300 may be an application executed on a computing device such as computing device 141 or workstation such as workstation 201. The interface 300 can include an information submission panel 302, an assistance panel 304, a reports panel 306, an information submission form panel 308, a request or view report button 310, a view submission button 312, and a search button 314. A user can interact with the information submission panel 302 to submit information to the system, which may be, for example, a business intelligence system. The submitted information may be stored on a computing device such as computing device 101 or server such as server 204. The user can select different types of information to submit to the system using the information submission panel 302, which will be described in more detail with respect to FIG. 4. Users with different permissions and/or different roles may receive notifications for different events.

The assistance panel 304 may provide the user with a list of reports or documents for which assistance from a requesting user or another party may be needed. The assistance panel can include a description of the document for which assistance is requested. A user can select the document and select an open report button to submit a command to the workstation to retrieve and open the selected document from the server. A computing device in the system (e.g., workstation 201) may identify documents to list in the assistance panel based on metadata. For example, documents to list in the assistance panel 304 may be stored in a particular folder on the server such as an assistance folder. In some aspects, documents to list in the assistance panel may be tagged with an assistance tag. An administrator may configure the particular tags or folders to associate with the assistance panel using a configuration interface of the system. For example, the administrator may assign documents in a specifically named folder or with a specific tag to be listed in the assistance panel 304.

The system can periodically scan for new assistance tags or scan the assistance folders for new or updated documents. In response to determining that new or updated documents have been saved to the system, the system can generate and display a notification of the new or updated documents to the appropriate users.

The reports panel 306 may list documents which are indicated as published or finalized. Similar to the assistance panel 304, the documents to be listed in the reports panel 306 may be determined based on a folder or tag associated with the tags. The user may select a document from the list to open and view. The user may have the option to view a summary of the status of various documents and submitted information requiring further action.

The information submission form panel 308 may contain fields in which the user can enter information to submit or store in the system. Different fields may appear depending on the type of information being submitted. For example, the type of information being submitted may be an accomplishment, trend, or challenge/risk. For an accomplishment event, the panel 308 may provide fields for the user to input information regarding what happened, who the relevant audience is of the information and why, any associated case identifiers, date of the occurrence, and regions impacted or affected by the event. For a trend, the panel 308 may provide fields for the user to input information regarding a description of the trend, associated case identifiers, direction of the trend (e.g., increasing, decreasing, static), and region that was impacted. For a challenge/risk, the panel 308 may collect information regarding a description of the challenge/risk, why the described event is a challenge or a risk, and any case identifiers to be associated with this reported challenge/risk.

The information submission may be stored in a key-value format with each prompt or field name corresponding to the key and the user's input in the field corresponding to the value. The information submissions may be stored as text files in the information submission storage location.

The request or view reports button 310 can be selected by the user to view a list of published reports or request a specific report. The tool can index any or all of the files in the published report storage location to provide a list of published reports. The tool can provide daily report metrics including the number of information submissions or cases awaiting an action plan, awaiting completion, and/or completed cases which is applicable to the team of the user.

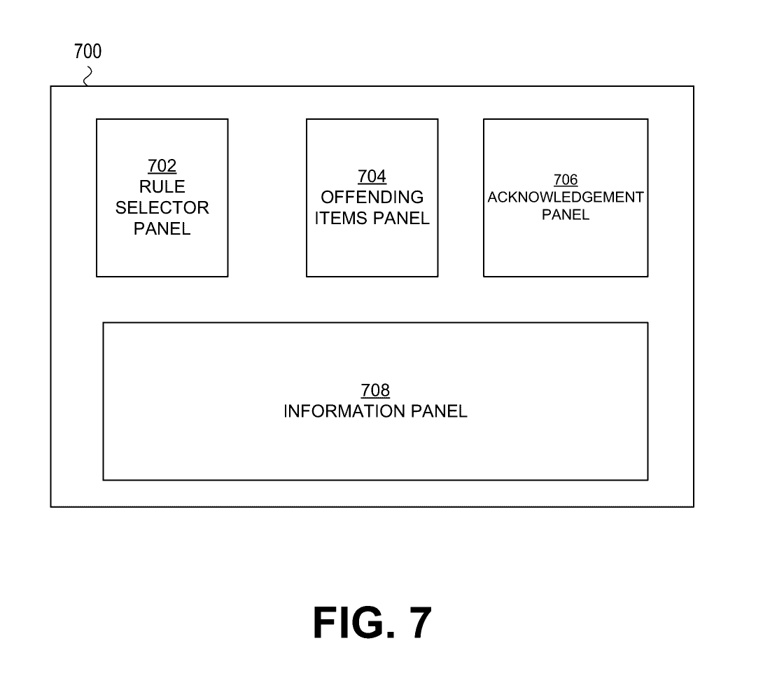

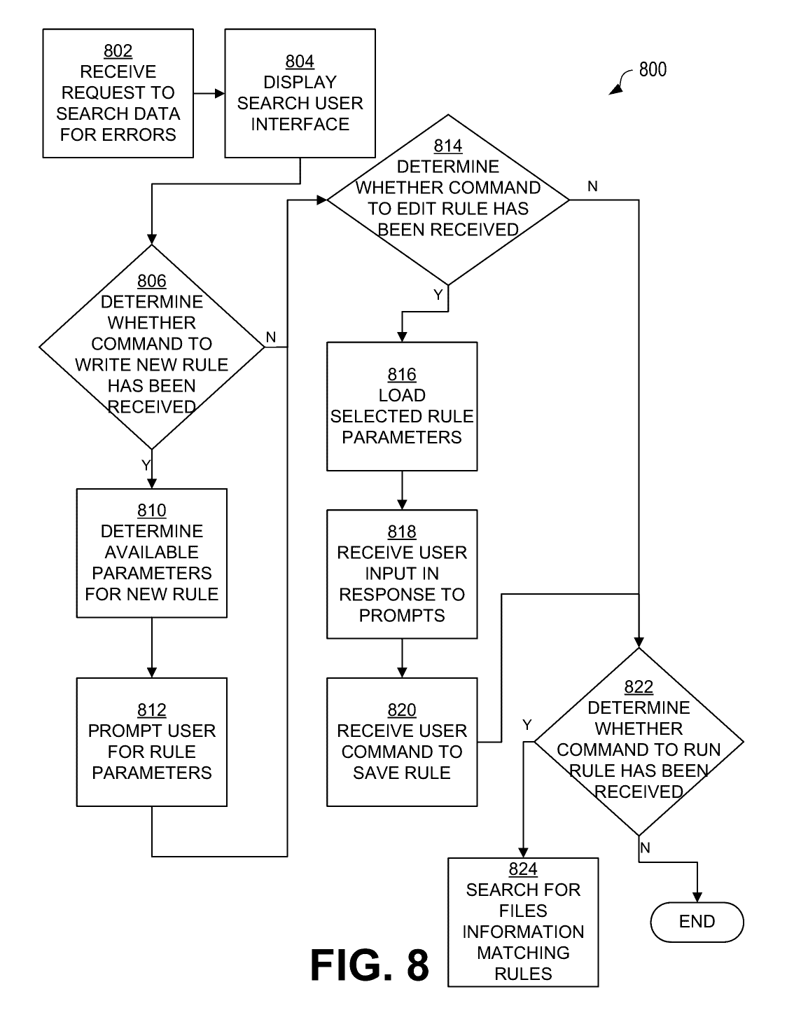

The view submissions button 312 can be selected by a user to view information submitted via the information submission form panel 308 and stored in the system which will be described in more detail with respect to FIG. 4. A user can select the search button 314 to search for errors in stored data which will be described in more detail with respect to FIGS. 7 and 8.

When the user interface 300 is closed by the user, the tool can continue executing or running in the background of a computing device. While running in the background, the tool can continue monitoring or checking for events about which to alert the user. The alerts may be provided in the form of a desktop notification, message (e.g., e-mail). The desktop notification may be a window which appears on the screen containing text describing the event which has occurred. There may be two different types of notifications a new report notification and a message notification. A new report notification may be used when a new published report is stored in the published report storage location or when feedback or assistance is required for a preliminary report. The new report notification may indicate the number of new reports since the last scan and include the name of the new report. A message notification may be used with text files and notify the user that the contents of the

FIG. 4 illustrates an example method of information submission and notification 400 according to one or more aspects described herein. The information submission may be via the information submission panel 302 and the information submission form panel 308. At step 402, the user may select an information type (e.g., accomplishment, trend, challenge/risk) to submit. At step 404, a computing device (e.g., workstation 201) can determine which information type has been selected. At step 406, the computing device can provide the appropriate fields or prompts for the user to enter the information in the information submission form panel 308. For example, the interface 300 can prompt for additional information based on whether the information type is an accomplishment, trend, or challenge or risk. At step 410, the user can enter the information and submit the information. At step 412, the system can store the information submission in the information submission storage location in the server. For example, the information can be stored as a text file in the server which can be parsed by the system.

At step 414, the system such as the computing device can determine whether new information has been submitted. For example, upon starting a component of the system or a tool on the computing device (e.g., an application executing on the computing device), the computing device can determine the user based on the user name and determine access privileges of the user. The computing device can then limit the information provided to the user to only information which the user has access privileges. For example, the user may be a member of one or more teams and can only access information available to members of the team (e.g., cyber forensics team, post incident review team). The computing device can scan the information submission storage location and determine which files are already stored or present. After determining an initial status of the information submission data, the computing device can periodically scan (e.g., every 2-5 seconds) to determine whether information submission data has changed or has been added (e.g., new information submission files, newly modified information submission files). In response to determining that information submission data has been changed or added, the tool can generate and display a notification (e.g., push notification) of a new submission for a user with a particular role (e.g., report generation role) at step 416. The notification may be in the form of a new window or screen appearing on a portion of the user's desktop and include a title and description of the event that occurred or other notification such as an e-mail message, text message, etc. The notification may indicate that new information has been submitted. The desktop notification may be provided in the program tray and/or provided using a Java notification application program interface (api). The newly submitted information may be used in generating the reports.

If at step 414 the tool determines that no new information has been submitted or following notification of a new submission at step 416, the tool can proceed to step 418. At step 418, the tool can determine whether a request to view team submissions has been received. For example, the user may select the view submission button 312 to open a view submissions interface and view all information submitted by teams of which the user is a member. In response to the request to view team submissions, the tool can scan the information submission storage location and compile an index or list of the submissions. The tool can present the list of submission and filter the list of submissions based on team, information type, submission month, submission year, region impacted, name of submitter, occurrence month, and/or occurrence year. The tool can show only the submissions meeting matching the filters. If the tool receives a selection of a submission from the list, the tool can retrieve the file associated with the selected submission and load the information submitted. For example, for an accomplishment, the tool can present a what happened panel and present the description of inputted for the what happened field for the selected file with a date of the occurrence. The tool can calculate a quality score of the information submission which will be described in more detail herein and present a quality score of the information submission of the selected submission.

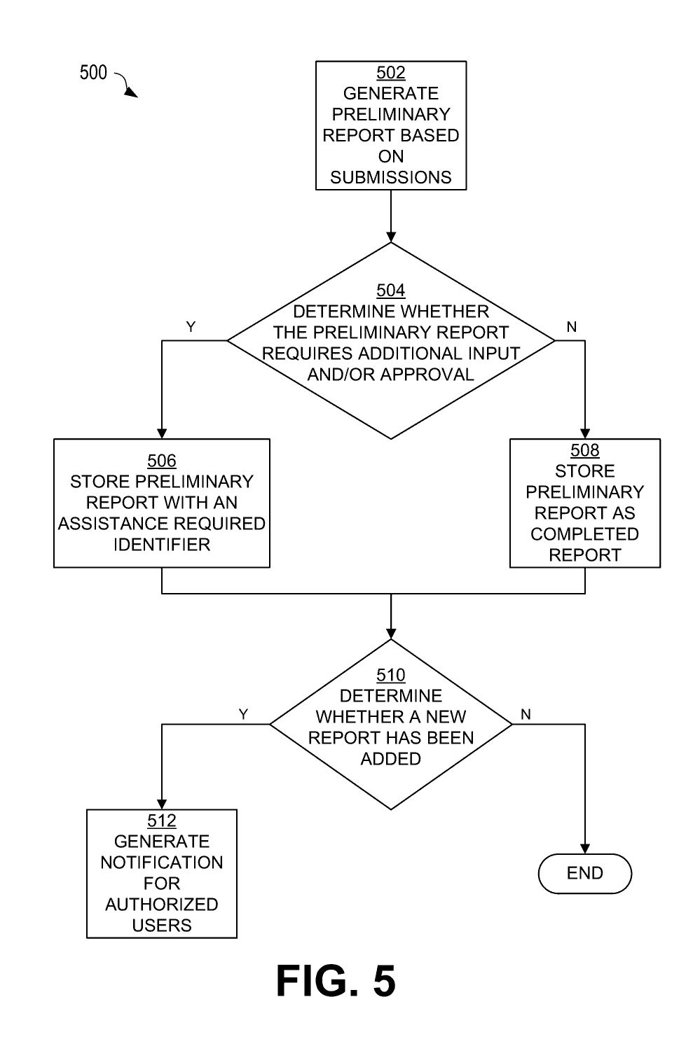

FIG. 5 illustrates an example method of report monitoring and notification according to aspects described herein. At step 502, a user in a report generator role can receive a request from another user for a new report based on the submitted information and generate a new report to store in the system. The report may be requested via the tool on the requesting user's computing device and may cause a notification to display on the report generator's computing device. The user can store the generated report as a preliminary or draft report which may require additional information and/or approval or as a completed or final report. The user can indicate via an interface of the tool whether to store the report with an assistance required identifier or in the assistance required storage location (e.g., folder or file) to indicate that additional information and/or approval is needed for the report. At step 504, the system can determine whether the report is to be stored with an assistance required identifier. If the report is to be stored with an assistance required identifier, the system can store the report in an assistance required storage location (e.g., file folder) and/or with an assistance required metadata tag at step 506. If further assistance and/or approval is not needed for the report, the system may store the report in a completed reports storage location at step 508. After assistance and/or approval of the report by the appropriate person(s) has been performed, the now approved report may stored as a completed report in the completed report storage location which may cause a notification to be displayed for the users of the designated team.

At step 510, the tool of a user in an analysis role may determine whether a new report has been added or stored in the system. The tool can periodically scan for new or modified reports directed to the user's team(s). If at step 510 the tool detects a new or modified report has been saved in the system, the tool can generate a notification for the user. If the tool does not currently detect a new or modified report, the tool can continue periodically scanning for new reports.

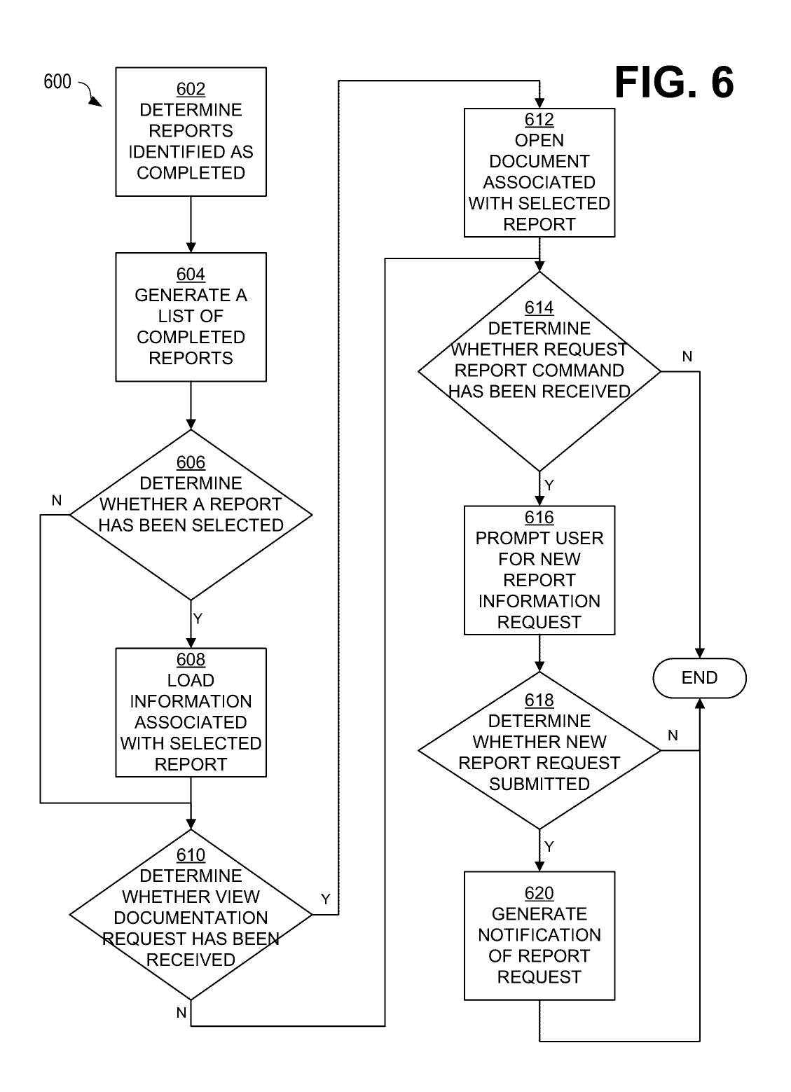

FIG. 6 illustrates an example method of requesting and viewing reports 600 according to aspects described herein. At step 602, the system or tool of a user can determine which reports have been identified as completed. For example, the completed reports may be stored in a specified storage location (e.g., file folder) and/or have a specified file name associated with completed reports and/or a specified tag associated with completed reports. At step 604, the tool can generate a list of completed reports which are available to the user based on the user's access permissions and/or team membership. The list of completed reports may be displayed to the user via an interface of the tool which can provide the user with options to view the reports. At step 606, the tool can determine whether a user has selected a report on the list. If the user has selected a report, the tool can proceed to step 608 and load the information associated with the report in an interface of the tool. For example, the tool can include fields for the report name, report description, intended audience, recurrence, estimated completion date, and/or whether the report is an automated report. Selecting a report may populate the fields with information from the report. Each time a user selects a report from the list the fields may be populated with information from the newly selected report. At step 610, the tool can determine whether a request to view documentation has been received. For example, the user can select a view document button on the interface to view the actual document of the selected report. If the tool has received a request to view the documentation, the tool can open a file location of the selected document and/or open the selected document in response to the request.

The tool may enable a user to request a new report using for example a request report button on the interface. At step 614, the tool can determine whether a request report command has been received. If a request report command has been received, the tool may retrieve a list of requested reports and provide fields for the user to enter information for a new report at step 616. For example, the tool may provide fields for the name of the new report, report description, intended audience, and/or recurrence. At step 618, a tool of a report generator user can determine whether a new report request has been submitted. The tool of the report generator user may be running in the background and periodically scanning the new report request file and/or storage location for an updated report request file and/or new report request file. At step 620, in response to determining that a new report request has been submitted, the tool of the report generator user can generate and display a notification as discussed herein. The tool can return to step 606 to continue monitoring for inputs to the tool from the user.

FIG. 7 shows an illustrative user interface of a search panel 700 of the tool according to aspects described herein. The user interface 700 can include a rule selector panel 702, an results or offending items panel 704, an acknowledgment panel 706, and an information panel 708. The search panel 700 can be used to execute a search to identify errors in an information management system (e.g., case management system). The search may be performed on matrices or files in a spreadsheet format (e.g., Microsoft Excel documents, Apple Numbers documents, Gnome Gnumeric documents). The rule selector panel 702 can load from a database or server a list of existing rules. The rules may be saved in a single document or in individual documents. The tool can parse the document for the title of the rule and the parameters of the rule. The rule selector panel may provide buttons for running a selected rule, writing a new rule, and/or editing a selected rule. The results panel 704 can display the search results of the selected rule, and the acknowledgement panel 706 provides an area where a user can provide a description indicating or acknowledging why an error exists in the case system. When the user selects an item from the results panel 702, the information panel 708 can load values associated with the selected item into fields in the information panel 708. The fields in the information panel may be, for example, the item owner, item status, date requested, date concluded, details, and/or updates.

When the user selects to write a new rule, the tool may provide fields for the user to input the rule name and the parameters of the rule as the rule query and may display a list of available fields. The list of available fields may be populated from the column and/or row names in the spreadsheets stored in the database or server. The available fields may include for example event identifier, date closed, date reported, primary incident manager, event category, risk severity, score, root cause, post incident review completion date, submitted date, submitter's name, event management status, case status and/or ticket name. The rule parameters specify for the tool to search the fields for the values specified in the rule query. For example, a rule may search for a data set or case where a complete action has been applied but a case completion date has not been provided. The rule query may search the case status field for a case with a completed value and a blank completion date field. The case identifiers of the results matching the rule may be returned in the results panel 702. Selecting the identifiers in the results panel 702 can provide more information about the case. A report listing the details of all the results may be generated. For example, a spreadsheet with each row corresponding to one of the case results may be generated with the columns listing the responsible team members, the results of the searched fields, and an acknowledgment column containing comments, if any, on the associated case.

To edit a rule, the user can select the edit rule button, and the selected rule name and rule query may be populated in the rule name and rule query fields for editing similar to writing a new rule.

FIG. 8 illustrates an example method of identifying relevant data 800 according to aspects described herein. The method of FIG. 8 may be implemented using the interface of the search panel 700. At step 802, the tool may receive a request to analyze or search data for errors via the selection of search button 314. In response to the selection of button 314, the tool may display interface 700 at step 804. At step 806, the tool can determine whether a command to write a new rule has been received. If no write rule command has been received, the tool can proceed to step 814 and determine whether a command to edit a selected rule has been received. If a write rule command has been received, the tool can proceed to step 810 and determine available parameters for the new rule. The tool may index all of the column names in a set of spreadsheet files and display the indexed column names as available fields or parameters for the new rule. For example, the tool can parse the spreadsheet files for the values in the first row and index the values in the first row as the available fields to search. At step 812, the tool can display fields for the user to input the rule name and rule query and display a list of the available fields to search. When the user completes entering the new rule and saves the rule, the tool can store the rule name and rule query in a key-value pair format in a master file or as a new individual file in the rule storage location of the database or server. In response to the saving of a new rule, the tool can refresh its listing of available saved rules.

At step 814, the tool can determine whether a command to edit a selected rule has been received. If a command to edit a selected rule has not been received, the tool can determine whether a command to run a rule has been received at step 822. If a command to edit a selected rule has been received, the tool can identify the selected rule and parse the file containing the stored rule for the rule parameters at step 816. The tool can populate the rule query and rule name fields for editing by the user. At step 818, the tool can receive the edits to the parameters in the rule query field and/or the rule name field. At step 820, the user can select the save button to save the edited rule, and the tool can update the name and/or parameters in the file for the selected rule.

At step 822, the tool can determine whether a command to run a rule has been received. If run rule command has not been received, the tool can return to waiting for the next user input or selection and/or check for selection of the various buttons on the interface by the user. If the user has selected a rule to run, the tool can execute the selected rule by searching the spreadsheet files for values which match the parameters in the rule query. Once the search is completed, the tool can load the results in the results panel 704. The tool can return to step 806 to continue monitoring for inputs to the tool from the user.

As briefly described earlier herein, the tool can calculate a quality score to measure the overall quality of information submitted. The quality score can be calculated in real-time as the user is entering the information. The quality score may be calculated after the user submits the information and stored with the information submission. The quality score may be calculated by determining the average length of a word within contextual fields (e.g., what happened field, target audience (e.g., team or person) and relevancy field, description of trend, description of challenge or risk). The length of each word (e.g., number of characters) in that field can be divided by the average word length, and these values may be added together to generate the quality score. The quality score may be calculated as follows where W equals the number of words in a contextual field and n is a word:

$$Average Word Length ( AWL ) = \frac{{\sum }_{n = 0}^{W} length ( n )}{W}$$

$$Quality Score ( QS ) = {{\sum }^{W}}_{n = 0} \frac{length ( n )}{AWL}$$

The tool may include a bug report feature to automatically generate a message such as an email message to an information technology (IT) specialist or administrator with error information from the most recent log files stored on the computing device.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space). Aspects of the disclosure may be implemented using various programming languages such as Java, C++, etc.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. A method, comprising:
determining, by a computing device, access permissions of a user of the computing device;
determining, by the computing device, information available to the user based on the access permissions of the user;
determining, by the computing device, a current status of information submissions, preliminary reports, and completed reports based on the access permissions of the user;
determining, by the computing device, information submission types available to the user based on the access permissions of the user;
determining, by the computing device, that at least one notification event of a plurality of notification events has occurred, the plurality of notification events comprising a new information submission has been received, a report generation request has been submitted, an assistance request has been submitted, and a completed report has been submitted; and
in response to determining that the at least one notification event has occurred, generating and displaying, by the computing device, a notification indicating how many of the at least one notification event has occurred and which of the at least one notification event has occurred based on the access permissions of the user.

2. The method of claim 1, wherein determining access permissions comprises:
determining a role of the user based on a user name of the user.

3. The method of claim 2, wherein generating and displaying the notification based on the access permissions of the user comprises:
determining whether to display the notification based on the role of the user.

4. The method of claim 1, further comprising:
periodically determining, by the computing device, whether the at least one notification event has occurred.

5. The method of claim 1, further comprising:
receiving, by the computing device, a request to search a database;
in response to receiving the request, displaying, by the computing device, a list of saved rules from a rule storage location and providing an option to write a new rule.

6. The method of claim 5, further comprising:
receiving, by the computing device, a selection of the option to write a new rule;
in response to the selection of the option to write a new rule, prompting a user for a rule name and rule parameters of the new rule;
receiving, by the computing device, the rule name and rule parameters of the new rule; and
saving, by the computing device, the new rule in the rule storage location.

7. The method of claim 5, further comprising:
receiving a selection of a first rule comprising at least one parameter from the list of saved rules;
receiving a command to execute the first rule;
in response to receiving the command, parsing a plurality of matrices to identify a first row comprising values matching the at least one parameter; and
in response to identifying the first row, returning an identifier associated with the first row in a results panel.

8. An apparatus, comprising:
at least one processor; and
a memory storing computer-readable instructions that, when executed by the at least one processor, cause the apparatus to:
determine access permissions of a user of the apparatus;
determine information available to the user based on the access permissions of the user;
determine a current status of information submissions, preliminary reports, and completed reports based on the access permissions of the user;
determine information submission types available to the user based on the access permissions of the user;
determine that at least one notification event of a plurality of notification events has occurred, the plurality of notification events comprising a new information submission has been received, a report generation request has been submitted, an assistance request has been submitted, and a completed report has been submitted; and
in response to determining that the at least one notification event has occurred, generate and display a notification indicating how many of the at least one notification event has occurred and which of the at least one notification event has occurred based on the access permissions of the user.

9. The apparatus of claim 8, wherein determining access permissions comprises:
determining a role of the user based on a user name of the user.

10. The apparatus of claim 9, wherein generating and displaying the notification based on the access permissions of the user comprises:
determining whether to display the notification based on the role of the user.

11. The apparatus of claim 8, wherein the memory further stores computer-readable instructions that, when executed by the at least one processor, cause the apparatus to:
periodically determine whether the at least one notification event has occurred.

12. The apparatus of claim 8, wherein the memory further stores computer-readable instructions that, when executed by the at least one processor, cause the apparatus to:
receive a request to search a database;
in response to receiving the request, display a list of saved rules from a rule storage location and providing an option to write a new rule.

13. The apparatus of claim 12, wherein the memory further stores computer-readable instructions that, when executed by the at least one processor, cause the apparatus to:
receive a selection of the option to write a new rule;
in response to the selection of the option to write a new rule, prompt a user for a rule name and rule parameters of the new rule;
receive the rule name and rule parameters of the new rule; and
save the new rule in the rule storage location.

14. The apparatus of claim 12, wherein the memory further stores computer-readable instructions that, when executed by the at least one processor, cause the apparatus to:
receive a selection of a first rule comprising at least one parameter from the list of saved rules;
receive a command to execute the first rule;
in response to receiving the command, parse a plurality of matrices to identify a first row comprising values matching the at least one parameter; and
in response to identifying the first row, return an identifier associated with the first row in a results panel.

15. One or more non-transitory computer-readable media having computer-executable instructions stored thereon that, when executed, cause at least one computing device to:
determine access permissions of a user of the at least one computing device;
determine information available to the user based on the access permissions of the user;
determine a current status of information submissions, preliminary reports, and completed reports based on the access permissions of the user;
determine information submission types available to the user based on the access permissions of the user;
determine that at least one notification event of a plurality of notification events has occurred, the plurality of notification events comprising a new information submission has been received, a report generation request has been submitted, an assistance request has been submitted, and a completed report has been submitted; and
in response to determining that the at least one notification event has occurred, generate and display a notification indicating how many of the at least one notification event has occurred and which of the at least one notification event has occurred based on the access permissions of the user.

16. The one or more non-transitory computer-readable media of claim 15, wherein determining access permissions comprises:
determining a role of the user based on a user name of the user.

17. The one or more non-transitory computer-readable media of claim 16, wherein generating and displaying the notification based on the access permissions of the user comprises:
determining whether to display the notification based on the role of the user.

18. The one or more non-transitory computer-readable media of claim 15, wherein the computer-executable instructions stored thereon that, when executed, cause at least one computing device to:
periodically determine whether the at least one notification event has occurred.

19. The one or more non-transitory computer-readable media of claim 15, wherein the computer-executable instructions stored thereon that, when executed, cause at least one computing device to:
receive a request to search a database;
in response to receiving the request, display a list of saved rules from a rule storage location and providing an option to write a new rule.

20. The one or more non-transitory computer-readable media of claim 19, wherein the computer-executable instructions stored thereon that, when executed, cause at least one computing device to:
receive a selection of the option to write a new rule;
in response to the selection of the option to write a new rule, prompt a user for a rule name and rule parameters of the new rule;
receive the rule name and rule parameters of the new rule; and
save the new rule in the rule storage location.
